(19) United States
(12) Patent Application Publication
(10) Pub. No.: US 2014/0193117 A1
(43) Pub. Date: Jul. 10, 2014

(54) Antivirus optical tap

(71) Applicant: Anthony Peter Polus, Herkimer, NY (US)

(72) Inventor: Anthony Peter Polus, Herkimer, NY (US)

(21) Appl. No.: 13/694,815

(22) Filed: Jan. 9, 2013

(51) Int. Cl. G02B 6/26

(52) U.S. Cl. CPC G02B 6/26
USPC 385/48

(57) ABSTRACT

An antiviral optical tap system for a fiber optic circuit that uses an Optical Circulator or an Isolator or any other unidirectional optical device that is connected to the secondary optical tap output of an optical tap that prevents unwanted optical signals or optical noise from entering a fiber optic circuit through the secondary optical tap output and allows optical signals to pass to an external device through the Optical Circulator or Isolator or any other unidirectional device.

### CROSS-REFERENCE TO RELATED APPLICATIONS

Non Applicable

### STATEMENT REGARDING FEDERALLY SPONSORED RESEARCH OR DEVELOPMENT

Non Applicable

### MICROFICHE APPENDIX

Non Applicable

### BACKGROUND FO THE INVENTION

1. Field of the Invention

This invention relates to the Field of Fiber Optic Signal Transmission. More specifically, the invention comprises a fiber optic tap system which provides additional advantages over a conventional fiber optic tap.

2. Description of Related Art

There are known conventional fiber optic taps that are used to divert a portion of an optical signal traveling in a fiber optic cable to a secondary fiber for analysis or other purposes. The drawback of these optical taps is that they are bidirectional allowing light to be diverted as well as inserted into the fiber optic cable through the Secondary Optical Tap Output thus allowing noise and other unwanted optical signals to be inserted into the fiber optic cable.

### BRIEF SUMMARY OF THE PRESENT INVENTION

The present invention is an Antivirus System comprised of a conventional optical tap plus an optical circulator and/or an optical isolator. The Antivirus System provides additional capability to a conventional fiber optic tap by blocking optical signals from being inserted back into the fiber optic tap through the Secondary Optical Tap Output.

### BRIEF DESCRIPTION OF THE DRAWINGS

FIG. 1 is a schematic view of the invention

### REFERENCE NUMBERS IN THE DRAWING

1- Prime Fiber Optic Cable
2- Input of Optical Tap
3- Secondary Optical Tap Output
4- Output
5- Secondary Fiber Optic Cable
6- Output of Optical Tap
7- Output of Prime Fiber Optic Cable
8- Optical Tap
9- Input to Circulator
10- Pass Thru Output of Circulator
11- Optical Circulator
12- Reflective Output of Optical Circulator
13- Fiber Optic Cable A
14- Fiber Optic Cable B
15- Input to Isolator
16- Isolator
17- Output of Isolator
18- Fiber Optic Cable C

### DETAILED DESCRIPTION OF THE INVENTION

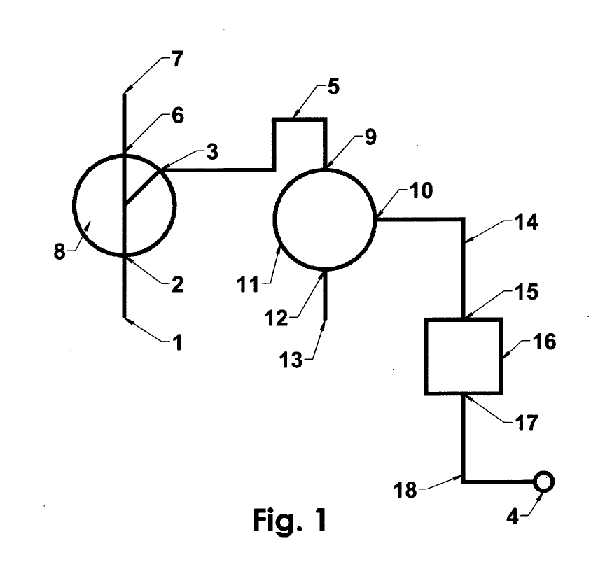

FIG. 1 shows a schematic view of the invention. An optic signal is inserted into the Prime Fiber Optic Cable 1 and travels in the cable to the Input of Optical Tap 2 where it enters the Optical Tap 8. The optical signal travels though the Optical Tap 8 where a portion of the optical signal is diverted to the Secondary Fiber Optic Cable 5 from the Secondary Optical Tap Output 3. The optical signal enters the Optical Circulator 11 at Input to Circulator 9 and travels to the Pass Thru Output of Circulator 10 to the Input of the Isolator 15. The Isolator 16 transfers the optical signal to the Output of the Isolator 17 where it is sent to a device attached to the Output of Fiber Optic Cable C 18 at Output 4. The output of the Optical Tap 6 is connected to the Output of Prime Fiber Optical Cable 7 where the balance of the input optical signal is sent. The invention only allows optical signals to be sent in an outward direction from the Optical Tap 8 to the Output 4. Optical signals traveling inward from the Output 4 are blocked by the Isolator 16 and/or Optical Circulator 11. Both an Optical Circulator 11 and an Isolator 16 are shown, both may be used as shown or either an Optical Circulator 11 or an Isolator 16 can be used separately. Any device that has similar unidirectional characteristics as the Optical Circulator 11 or Isolator 16 can be substituted in place of the Optical Circulator 11 or Isolator 16 or the Optical Circulator 11 and the Isolator 16.

FIG. 1 shows an Optic Tap 8, an Optical Circulator 11 and an Isolator 16. The Optical Tap 8 can be a fused biconic taper coupler/splitter or an optical filter or any other device that will divert part of the input signal to the Secondary Optical Tap Output 3. The Optical Tap 8 functions to divert a part of the input optical signal inserted at Input to Optical Tap 2 to the Secondary Optical Tap Output 3. The Optical Tap 8 is bidirectional, optical signals can travel in and out of the Optical Tap 8 through the Secondary Optical Tap Output 3. An Optical Circulator 11 is a device that uses techniques that allows optical signals to pass in only one direction thus being unidirectional. Optical signals are blocked from entering the Input to Circulator 9 from Pass Thru Output of Circulator 10 and Reflective Output of Optical Circulator 12. An Optical Circulator 11 may have other outputs that are also blocked from sending signals to Input to Circulator 9. An Isolator 16 is a device that uses techniques that allows optical signals to pass in only one direction thus being unidirectional. Optical signals are blocked from entering the Input to Isolator 15 from the Output of Isolator 17 but allow optical signals to pass from Input to Isolator 15 to Output of Isolator 17.

FIG. 1 shows a schematic of the invention. The Optical Tap 8 is available with different characteristics and in different sizes and different split ratios with a typical 250 micron coupler being 70 mm long and 3 mm in diameter. The Optical Circulator 11 is available with different characteristics and is typically 60 mm in length and 6 mm in diameter. The Isolator 16 is available with different characteristics and is typically 65 mm in length and 6 mm in diameter. The Optical Tap 8, the Optical Circulator 11 and the Isolator 16 can be tied in a series as shown in FIG. 1 by fusion splicing. The invention can be placed in any type of an enclosure for ease of use.

Having described my invention I claim:

1. An optical tap system that consists of an optical tap, an optical circulator, an Isolator or any other unidirectional optical signal device where the optical tap Secondary Output is connected to an Optical Circulator or Isolator or any other unidirectional device and blocks optical signals from entering the optical tap Secondary Output from an external source and allows optical signals to pass to an external device through the Optical Circulator or Isolator or any other unidirectional device.

2. An optical tap system that consists of an Optical Circulator, an Isolator or any other unidirectional optical device that is connected to the Secondary Output of an existing optical tap that blocks optical signals from entering the optical tap from an external source and allows optical signals to pass to an external device through the Optical Circulator or Isolator or any other unidirectional device.
